(19) United States
(12) Patent Application Publication
(10) Pub. No.: US 2014/0340185 A1
(43) Pub. Date: Nov. 20, 2014

(54) Rotary Connection for Electric Power Transmission

(71) Applicants: Pierce Verleur, Moorpark, CA (US); Alexander Ghibu, Fullerton, CA (US); Saeed Alipour, Laguna Niguel, CA (US)

(72) Inventors: Pierce Verleur, Moorpark, CA (US); Alexander Ghibu, Fullerton, CA (US); Saeed Alipour, Laguna Niguel, CA (US)

(21) Appl. No.: 14/131,791

(22) PCT Filed: Aug. 15, 2012
(86) PCT No.: PCT/US12/50896

§ 371 Date: Jun. 16, 2014

Related U.S. Application Data
(60) Provisional application No. 61/575,271, filed on Aug. 16, 2011.

(51) Int. Cl. H01F 38/18; H01F 38/14; H02J 5/00

(52) U.S. Cl. CPC H01F 38/18; H02J 5/005; H01F 38/14
USPC 336/120

(57) ABSTRACT

A rotor is rotatable on an axis within a stator. The rotor and stator each have facing coupled magnetic fields formed by electric coils positioned to produce axial force and radial magnetic filed. Stacked laminations are positioned to extend along the length of the rotor axis and the planes of the laminations lie parallel to the axis. There are several lamination packs arranged around both the rotor and the stator so as to shape the inter-engaging magnetic fields for maximum coupling across the rotor/stator airgap with minimum eddy current losses in the laminations. In this way, electric power is transmitted across a rotating coupling without rubbing or other wear contact to provide a long life.

### BACKGROUND

There are a number of electro mechanical conditions in which electric power must be transferred across a rotary structure. This happens in wound rotor electric motors, where slip rings are used to power a rotating field coil. Slip rings are used in various types of rotating machinery which require the transmission of power across from one part to another which are rotating with respect to each other. Slip rings with brushes engaging thereon are very successful in ordinary use. However, they are subject to wear and thus are not completely trouble free. Regular brush replacements must be accomplished for continuing reliable use.

Attempts have been made to utilize a magnetic connection between relative rotating parts. So far this has not been successful except in cases of low power, such as instrumentation. In such devices the eddy current losses are very high. The problem of such devices at present is that there has not a been construction whereby the magnetic field can be properly shaped in the rotor and in the stator of the relatively rotating parts for power transfer with minimum losses.

### SUMMARY OF THE INVENTION

To aid in the understanding of this invention it can be stated in essentially summary form that it is directed to an electric power device having a rotor and a stator, with the rotor rotating on an axis and the stator configured around the same axis. The rotor and stator each have electromagnetic coils to produce an electric field and iron substantially planar laminations for magnetic field control. The coils and laminations are positioned to produce a magnetic field across to rotor/stator gap. They are positioned to produce force substantially parallel to the axis of rotor rotation. These laminations are positioned in groups which are positioned so that their planes are oriented as radially as possible with respect to the rotor axis so as to shape the magnetic field so that it is as radial as possible when it crosses the air gap between the rotor and the stator and reduces eddy currents. With such a configuration it is possible to transmit large amounts of electric power at reasonable efficiency with minimum eddy current losses across the rotating joint to achieve a rotary connection which has no mechanical connection outside of the bearings which position the rotor within the stator to achieve a long, trouble free life. The laminations of associated windings can be arranged for single-phase or multiple-phase alternating current electric power transmission.

It is thus a purpose and advantage of this invention to provide a rotary connection for electric power transmission which has no mechanical parts in engagement, outside of the bearings which support the rotor and the stator and wherein the energy transfer produces no significant torque between the rotor and stator.

It is another purpose and advantage of this invention to provide a rotary connection for alternating current electric power transmission which achieves efficient magnetic field coupling with minimum losses so that large amounts of power can be transmitted across between the relatively rotating rotor and stator.

It is another purpose and advantage of this invention to provide a continuous magnetic flux path by proper lamination design so that the flux flows in the axially positioned planar lamination sheet in each lamination without the need for traveling through a parasitic air gap, but only the rotary air gap between the stationary and rotary portions of the lamination, thus completing the magnetic circuit.

It is another purpose and advantage of this invention to provide thin sheet iron laminations which are positioned so that their planes are always close to radial with respect to the rotor axis with their planes lying on the rotor axis.

It is another purpose and advantage of this invention to position and configure the magnetic coils and laminations so that they lie radially with respect to the rotational axis with their planes lying on the rotational axis to produce substantially zero torque and reduce core losses, excitation current, and leakage loss.

It is another purpose and advantage of this invention to provide rotary connection for alternating electric power transmission which is very close to the transformer efficiencies found in stationary transformers without relatively rotating parts by utilizing axially positioned laminations.

It is another purpose and advantage of this invention to construct a rotary connection for electric power transmission which has lower excitation current, low eddy current losses and low leakage inductance to achieve good efficiency in a structure which permits alternating power transmission between the relatively rotating rotor and stator.

It is another purpose and advantage of this invention to provide a rotary connection for alternating current electric power transmission so that adequate power can be transmitted so as to replace conventional slip rings in many applications, particularly where high reliability or low maintenance is required, such as for transmitting power from wind turbines and rotating solar and the like.

Other purposes and advantages of this invention will become apparent from a study of the following portion of the specification, the claims, and the attached drawings.

### BRIEF DESCRIPTION OF THE DRAWINGS

FIG. 1 is a perspective view of the rotary connection for electric power transmission in accordance with this invention.

FIG. 2 is a perspective view of the stator, with the rotor and the bearing spider removed.

FIG. 3 is a section through the rotor and stator as seen generally along the line 3-3 of FIG. 1.

FIG. 4 is perspective view of the laminations of the rotor in the assembled condition before potting.

FIG. 5 is schematic drawing of the assembly, taken as a section through the shaft center line, for a single-phased device.

FIG. 6 is a similar schematic view showing three coil and lamination structures, similar to the structure of FIG. 5, arranged along the shaft to provide a three-phase device.

FIG. 7 is a view similar to FIG. 6, but showing the laminations of the three-phase device formed of the same lamination stock.

FIG. 8 is a plan view of a single layer of stator lamination stock, for the three-phase device of FIG. 7.

FIG. 9 is a view similar to FIG. 8, showing a single layer of rotor lamination stock.

FIG. 10 is a longitudinal section through the three-phase rotary transformer device.

### DESCRIPTION OF THE PREFERRED EMBODIMENT

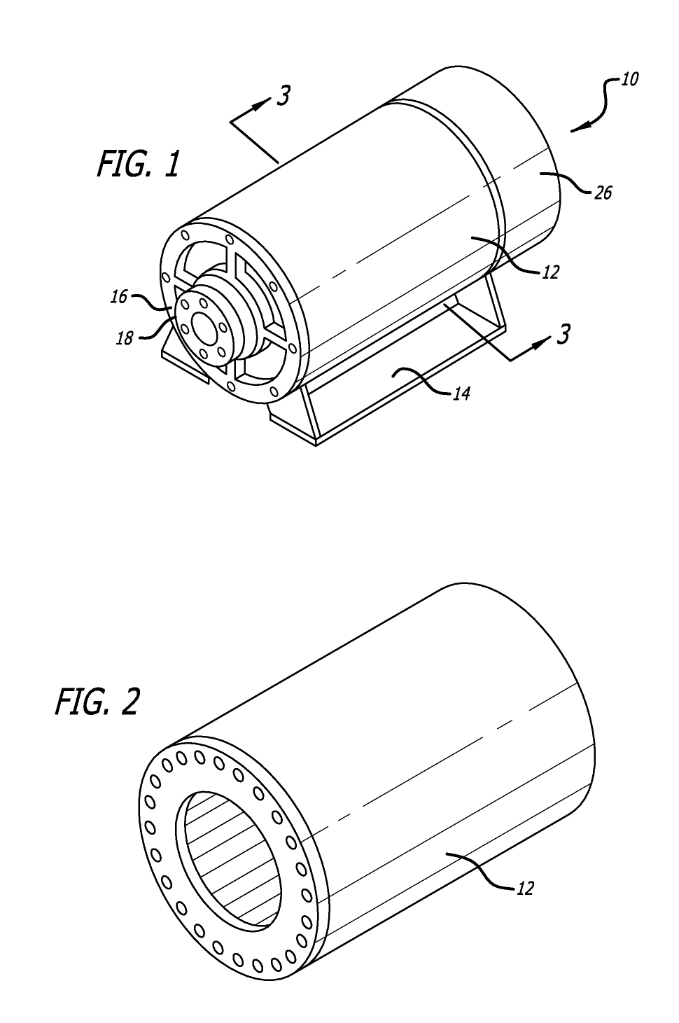

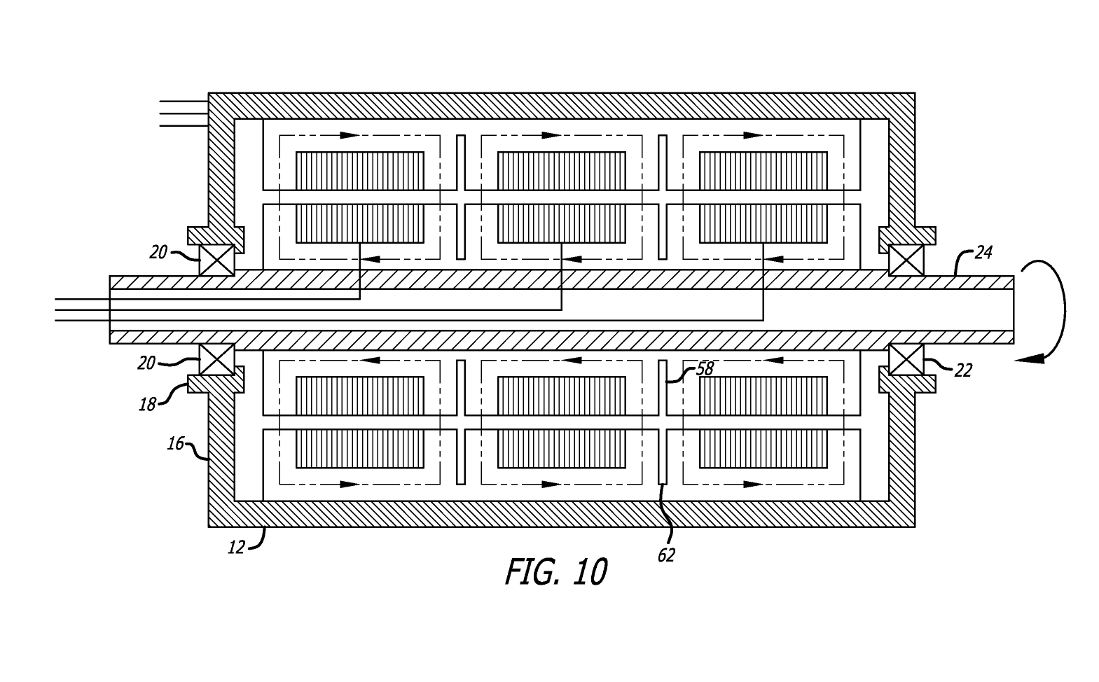

The rotary transformer or rotary connection for electric power transmission of this invention is generally indicated at 10 in FIG. 1. The rotary transformer has a stator frame 12 which is mounted on the base 14. This base is suitable for attachment to supporting structure. Each end of the stator frame carries a bearing spider. The near bearing spider is indicated at 16 in FIG. 1. The bearing spider 16 carries a bearing housing 18 which supports and holds bearing 20, see FIG. 10. FIG. 10 also shows that the other end of the stator frame carries bearing 22. These bearings rotatably carry shaft 24. The rotational axis of shaft 24 defines the axis of the entire structure. The bearing spiders are preferably open, as seen in FIG. 1 to permit axial flow of air through the rotary transformer. To aid in this airflow, to enhance cooling, a fan can be positioned within fan housing 26 to encourage axial airflow through the device.

When electrical current passes through a conductor it produces a force at a right angle to the direction of current and produces a magnetic field at a right angle to both the current and force. The purpose of the rotary transformer 10 is to permit substantial electric power transfer from the relatively stationary stator to the relatively rotational rotor, or vice versa, with minimum eddy current losses. The magnetic field must go across the gap between rotor and stator to produce the energy transfer therebetween. Torque is not desired in this structure, so the magnetic coils are positioned to produce the force in the axial direction where it is taken up in thrust bearings. The laminations are positioned to minimize eddy current losses caused by the magnetic field.

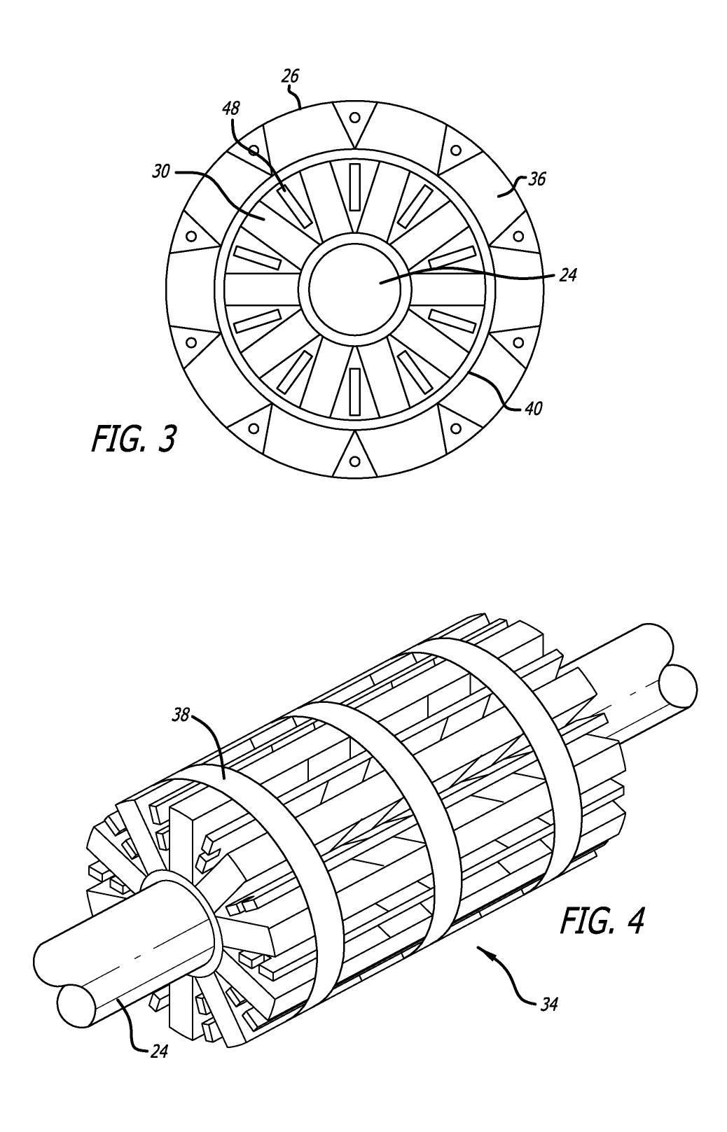

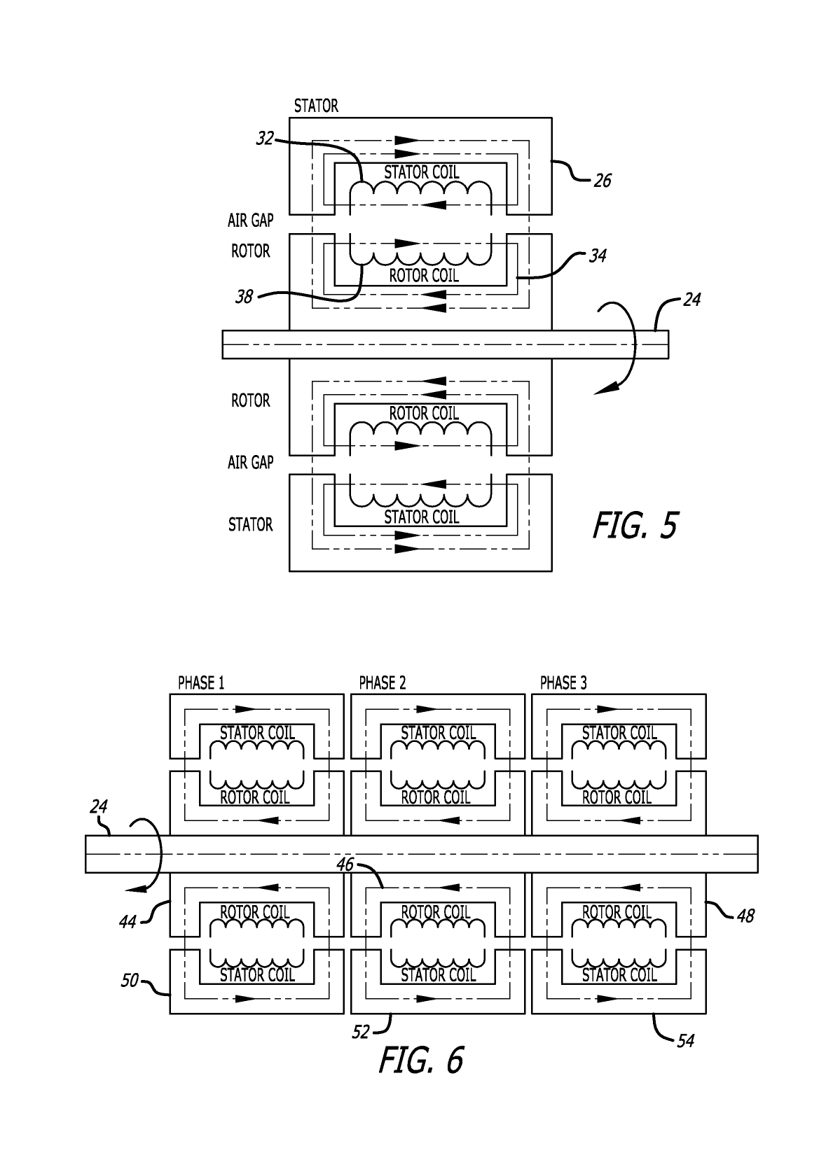

Instead of by use of slip rings, energy transfer across the rotor/stator interface is accomplished in this structure by means of a coupled magnetic field. Schematically this is illustrated in FIG. 5. The stator lamination pack 28 is a plurality of C-shaped laminations suitable for shaping the magnetic field. The laminations are of conventional thin low carbon iron laminations which are varnish insulated to prevent current between the laminations and joined together in a rectangular lamination pack, seen axially in FIG. 3.

A plurality of stator lamination packs is shown in FIG. 3. The lamination packs are arranged with their laminations as radially positioned as possible, as defined by the rotational axis of the rotor, with the laminations lying parallel to the rotational axis. Another stator lamination pack is indicated at 30. An electric stator coil 32 is indicated in FIG. 5. The purpose of the stator coil and the stator lamination pack is to exchange energy between electric field and magnetic field. In the present structure, the energy transfer can go either way.

Rotor 34 is mounted on shaft 24. The FIG. 5 rotor 34 is configured as a single-phase rotor. In FIG. 10, it is configured as a three-phase rotor. In referring to the schematic single-phased diagram of FIG. 5, the rotor 34, as seen in perspective in FIG. 4, is made up of plurality of lamination packs. In the single-phase example of FIG. 5, the lamination packs are made up of thin, soft iron, C-shaped laminations which are insulated from each other by varnish and are stacked into parallel stacks. The packs are assembled around shaft 24 and are positioned with the lamination planes positioned radially with respect to the axis, with the lamination planes extending parallel to the axis. This is seen in the cross section of FIG. 3 where rotor lamination pack 36 is seen. There is a plurality of such packs positioned around the axis and secured to the hollow shaft 24. Rotor coil 38, see FIG. 5, is associated with the lamination pack 34 and interchanges electro-magnetic field energy therebetween. The rotor coils are circumferential, as seen in FIG. 4. The rotor pack faces the stator pack across air gap 40. The air gap is defined by the cylindrical surfaces of the facing rotor and stator lamination packs. The air gap is as small as possible to avoid magnetic losses.

The stator and rotor core laminations must be configured and assembled to form a tight and highly magnetic core structure. It is necessary to configure the lamination stacks to form the lowest possible non-lamination spaces. As seen in FIGS. 3 and 4, the rotor lamination spaces are filled out by rotor supplemental lamination packs. As seen in FIG. 3, the principal rotor packs extend from the shaft to the air gap. Since the lamination packs each have parallel outside walls, due to the rectangular configurations of laminations, and since the lamination packs are positioned radially with respect to the axis, toward the rotor surface, gap spaces between the principal lamination packs are created. In order to improve magnetic efficiency, supplemental lamination packs are created. Supplemental rotor lamination pack 42, seen in FIG. 3, fills the pie-shaped space between the radially extending parallel-sided principal lamination packs. These rectangular lamination packs necessarily leave spaces therebetween when they are assembled around an axis or assembled around a cylindrical air gap. These gaps can be utilized for cooling or they can be filled with a high reluctance, high resistance potting material. A prototype 19 kilowatt rotary transformer was constructed in accordance with this design. The prototype showed a 95% decrease in eddy current losses as compared to prior rotary transformer design.

A single-phase example of a rotary transformer has been discussed so far and has been schematically illustrated in FIG. 5. FIG. 6 shows a three-phase rotary transformer which is essentially three of the structures of FIG. 5 placed endwise on the shaft 24. The first-phase rotor 44, the second-phase rotor 46, and the third-phase rotor 48 are axially positioned along the shaft 24, with a space therebetween to avoid magnetic coupling between the rotor laminations. Around the three rotors are respectively positioned stators 50, 52, and 54, which are respectively magnetically coupled with the rotors across the air gap. The wire connections for the windings of the rotor coil go out through the hollow central shaft which defines the axis.

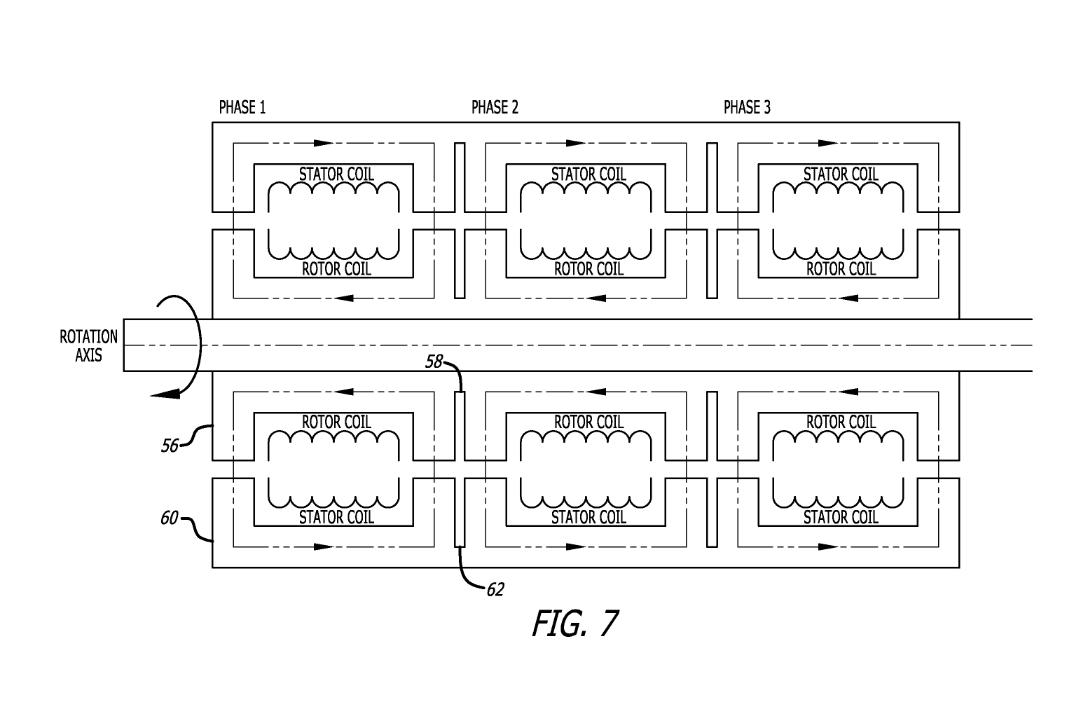

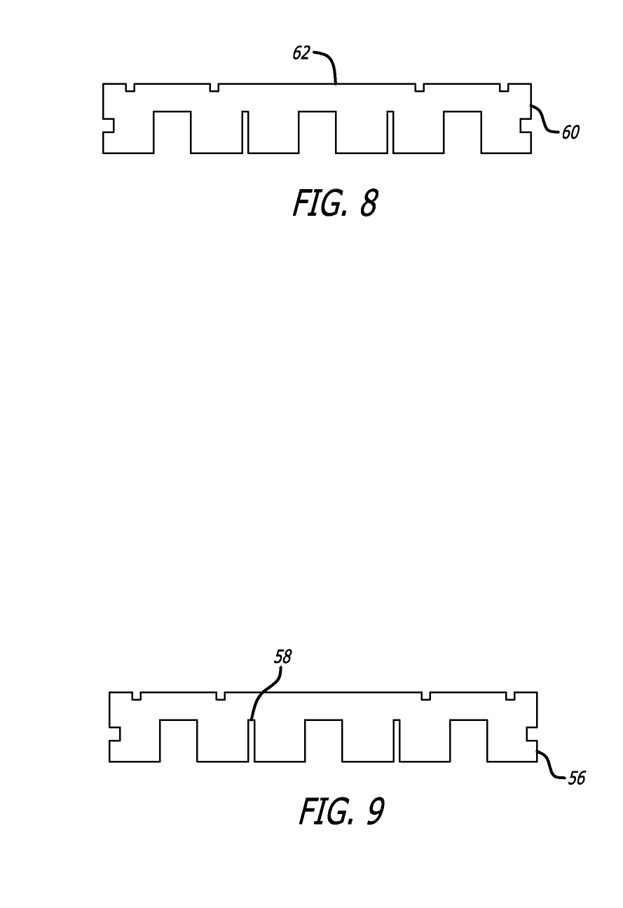

The construction for a three-phase device can be simplified by making the lamination packs in one piece for all three phases. FIG. 7 shows the mechanical equivalent wherein the laminations are made in one piece. However, to avoid magnetic coupling between adjacent phases, rotor laminations 56 have notch 58 therein. The same is true in the stator lamination 60 which has a notch 62. This is also illustrated in FIG. 8 for the stator and in FIG. 9 for the rotor lamination packs.

This construction permits electric power to be transmitted across rotary machinery in a manner that is of minimum energy loss and is free of wear and thus has a long, reliable life.

This invention has been described in its presently contemplated best mode and it is clear that it is susceptible to numerous modifications, modes, and embodiments within the ability of those skilled in the art and without the exercise of the inventive faculty.

1. A rotary connection structure for electric power transmission comprising:
a stator, means to support said stator, said stator including bearings defining an axis;
a shaft on said axis, a rotor on said shaft;
stator laminations, said stator laminations being formed of substantially planar sheets of low reluctance material stacked against each other, at least some of said laminations lying in a plane in which lies on said axis, electric coils engaged with said stator laminations to interchange energy with said stator laminations; and
a plurality of laminations on said rotor, said rotor laminations being from the plurality of substantially planar lamination sheets of low reluctance material, planes defined by said lamination sheets lying on said axis, rotor coils positioned on said rotor and inter-engaged with said rotor laminations to exchange energy therewith so that energy can be interchanged between said stator coils and said rotor coils while said rotor is rotating on said axis.

2. The rotary connection of claim 1 wherein said laminations are formed into lamination packs, each containing a plurality of lamination sheets, said lamination packs being arranged around said axis so that the plane of one of said lamination sheets in a lamination stack lies on said axis.

3. The rotary connection structure of claim 2 wherein said stator laminations have an interior face and said rotor laminations have an exterior face, said interior face of said stator laminations and said exterior face of said rotor laminations each being substantially cylindrical around said axis and lie closely adjacent to each other.

4. The rotary connection structure of claim 3 wherein said rotor electric coil is positioned circumferentially around said rotor and around said laminations.

5. The rotary connection structure of claim 4 wherein said rotor laminations have a coil groove on the exterior thereof and said rotor electric coil is engaged in said groove circumferentially around said rotor.

6. The rotary connection structure of claim 1 wherein there is a single lamination assembly of lamination stacks in the axial direction, suitable for single-phase electric power transmission.

7. The rotary connection structure of claim 1 wherein there are three axially positioned sets of rotor lamination stacks and an equivalently positioned three sets of stator lamination stacks to permit three-phase power transmission.

8. The rotary connection structure of claim 7 wherein said three axially positioned sets of rotor lamination stacks are made with contiguous lamination separated by notches to separate adjacent magnetic fields.

9. The rotary connection structure of claim 8 wherein said shaft is a hollow shaft and said rotor coils are connected to wires within said hollow shaft.

10. A rotary connection structure comprising:
a stator frame, said stator frame having structure thereon for mounting said stator frame, bearing structure in said stator frame, said bearing structure being configured for supporting a rotatable shaft within said stator frame, a shaft mounted within said stator frame, said shaft being rotatable on a rotational axis;
magnetic laminations mounted within said stator frame, said magnetic laminations being formed of sheets of lamination iron secured together in lamination packs, a plurality of said lamination packs being positioned within said stator frame to form a stator, said lamination packs being oriented so that at least one of said laminations in each of said lamination packs lies parallel to said axis so that said plurality of lamination packs form a stator having laminations parallel to said axis, at least one electric stator coil to interchange energy with said stator laminations; and
a rotor on said shaft, said rotor being formed of a plurality of lamination packs, each of said lamination packs being formed of a plurality of layers of lamination iron, said lamination packs being oriented so that at least one of said lamination sheets in each lamination pack defines a plane which it is parallel to said axis and said axis lies in said plane, a rotor coil, said rotor coil being associated with said rotor laminations to interchange energy with said rotor laminations, said rotor laminations being magnetically inter-engaged with said stator laminations so that magnetic energy can be exchanged therebetween so as to permit transfer of energy between relatively rotating parts.

11. The rotary connection structure of claim 10 wherein the exterior of said rotor and the interior of said stator are each substantially cylindrical and are spaced so that magnetic energy can be interchanged between said stator and said rotor.

12. The rotary connection structure of claim 11 wherein said rotor is comprised of a plurality of lamination packs, each extending substantially radially outward from said shaft and extending to the exterior of said rotor, each of said packs being substantially rectangular with said laminations therein extending parallel to said axis.

13. The rotary connection structure of claim 12 wherein said lamination packs are principal lamination packs and further including supplemental lamination packs which lie between said principal lamination packs where said principal lamination packs are spaced from each other.

14. The rotary connection structure of claim 10 wherein said rotor has a substantially cylindrical exterior surface around said axis and said stator has a substantially cylindrical interior surface around said axis, said surfaces being spaced closely with respect to each other to define an air gap therebetween.

15. The rotary connection structure of claim 10 wherein there is a plurality of electric coils in the axial direction on each said rotor and said stator so that plural phase power can be transmitted therebetween.

16. The rotary connection structure of claim 10 wherein said rotor coils are wrapped circumferentially around said rotor, said rotor laminations having recesses therein to receive said coils.

17. The rotary connection structure of claim 16 wherein there is a plurality of axially positioned coils wrapped around said rotor and there is a corresponding plurality of stator coils so that multiple phases can be transmitted.

18. The rotary connection structure of claim 10 wherein each of said lamination packs has a coil recess therein and said rotor coil is wound circumferentially wherein said recess.

19. The rotary connection structure of claim 18 wherein there is a plurality of recesses in each of said rotor lamination packs and there is a corresponding plurality of coils circumferentially wound in said lamination recesses in said rotor and there is a notch between said recesses to limit magnetic coupling between recesses in said rotor lamination packs.

20. A rotary connection structure for electric power transmission comprising:
a stator, means to support said stator, said stator including bearings defining an axis;
a shaft on said axis, a rotor on said shaft;
an electric coil in said rotor, said electric coil being positioned to produce a magnetic field radially of said rotor and produce a force which is axial of said rotor; said stator surrounding said rotor and providing a magnetic airgap therebetween, stator laminations being formed of substantially planar sheets of low reluctance material stacked against each other, at least some of said laminations lying in a plane in which lies on said axis, electric stator coils engaged with said stator laminations to interchange energy with said stator laminations, said stator coils being positioned produce a magnetic field across said gap and an axial force; and
a plurality of laminations on said rotor, said rotor laminations being from the plurality of substantially planar lamination sheets of low reluctance material, planes defined by said lamination sheets lying on said axis, rotor coils positioned on said rotor and inter-engaged with said rotor laminations to exchange energy therewith so that energy can be interchanged between said stator coils and said rotor coils while said rotor is rotating on said axis.
